(19) United States
(12) Patent Application Publication
(10) Pub. No.: US 2017/0206877 A1
(43) Pub. Date: Jul. 20, 2017

(54) AUDIO SYSTEM ENABLED BY DEVICE FOR RECOGNIZING USER OPERATION

(71) Applicant: IMPRESSIVOKOREA, INC., Seoul (KR)

(72) Inventor: Youngseok AHN, Seoul (KR)

(73) Assignee: IMPRESSIVOKOREA, INC., Seoul (KR)

(21) Appl. No.: 15/477,334

(22) Filed: Apr. 3, 2017

Related U.S. Application Data
(63) Continuation of application No. PCT/KR2015/010522, filed on Oct. 5, 2015.

(30) Foreign Application Priority Data
Oct. 3, 2014 (KR) 10-2014-0133602

(51) Int. Cl. G10H 1/18; G10H 1/34; G10H 1/46

(52) U.S. Cl. CPC G10H 1/18; G10H 1/46; G10H 1/344; G10H 2220/096; G10H 2220/161; G10H 2220/275

(57) ABSTRACT

According to one aspect of the present invention, there is provided an audio system. The audio system includes a user computer to output a note; a musical instrument unit to transmit a first electrical signal to the user computer, and a user operation recognition device attached to or disposed at a specific part of the musical instrument unit to transmit a second electrical signal to the user computer. The user operation recognition device is to change or adjust a note of the musical instrument unit on the basis of a touch applied to the user operation recognition device. The user operation recognition device includes a substrate, and at least one unit cell including a first partial electrode formed along a first pattern on the substrate and a second partial electrode formed along a second pattern on the substrate.

### CROSS-REFERENCE TO RELATED APPLICATIONS

This application is a continuation application of Patent Cooperation Treaty (PCT) international application Serial No. PCT/KR2015/010522, filed on Oct. 5, 2015, and which designates the United States, which claims priority to Korean Patent Application Serial No. 10-2014-0133602, filed on Oct. 3, 2014. The entire contents of PCT international application Serial No. PCT/KR2015/010522 and Korean Patent Application Serial No. 10-2014-0133602 are hereby incorporated by reference.

### FIELD

The present invention relates to an audio system implemented by a device for recognizing a user operation.

### BACKGROUND

Recently, mobile smart devices such as smart phones and smart pads having various functions and powerful computing capabilities are widely used. Among such mobile smart devices, there are relatively small-sized wearable devices that can be worn and carried on a body of a user (e.g., a smart glass, a smart watch, a smart band, a smart device in the form of a ring or a brooch, a smart device directly worn on or embedded in a body or a garment, etc.)

Meanwhile, a wearable device is restricted to be small-sized and worn on a user's body, and generally includes a touch-based user interface means such as a touch panel to simplify its components and improve space efficiency.

As one example of prior art, capacitive sensing type touch panels are most widely used in wearable devices. A capacitive sensing type touch panel can use ITO electrodes arranged in the form of a matrix on a substrate, and horizontal or vertical electrodes connected to the ITO electrodes, to detect a change in capacitance due to finger proximity and recognize a touch position. Further, the capacitive sensing type touch panel can recognize, for example, where the currently touched point is moved and whether the touch is released, and can recognize a multi-touch operation in which multiple points are simultaneously touched.

However, the capacitive sensing type touch panel has a limitation that it is difficult to recognize the intensity and direction of pressure or force generated by the touch. Further, when a user touches a small-sized display screen (i.e., a display screen provided with a touch panel) of a wearable device such as a smart watch, information displayed on the display screen is obstructed by the user's finger, causing inconvenience in that it becomes difficult for the user to read the information properly. Particularly, when the user performs a multi-touch operation such as a pinch operation for magnification or reduction, there arises a problem that most of the display screen is obstructed by the multiple fingers contacting the display screen, or it becomes difficult to perform the multi-touch operation itself due to spatial limitation. In order to address the above inconvenience or problem, there has been introduced a bracelet-type wearable device with a display screen having a slightly increased size. However, there are still great difficulties in inputting various touch operations.

As another example of the prior art, IFSR (interpolating force sensitive resistance) type touch panels have been introduced. An IFSR type touch panel can not only recognize a touch but also pressure involved in the touch. Specifically, it can recognize both the touch and pressure using ITO electrodes arranged in the form of a matrix on a substrate, and a pressure sensing material disposed on a layer above or below the ITO electrodes. Here, a force sensing resistor (FSR) or the like can be used as the pressure sensing material, and the FSR is a material characterized in that electric resistance thereof is changed with the applied pressure. However, since the ISFR type touch panel cannot but have a complicated multi-layer structure, there arises a problem that unintended noises can occur when the touch panel is bent, and it is difficult to filter such noises. Therefore, the ISFR type touch panel is not suitable for use in a flexible wearable device.

As yet another example of the prior art, resistive type (or 4-wire type) touch panels have been introduced. Specifically, a resistive type touch panel can recognize both touch and pressure by detecting voltage generated at a position where a touch operation involving predetermined pressure is input, using two resistive films coated with ITO and a dot spacer disposed with a predetermined interval between the resistive films. However, the resistive type touch panel is disadvantageous in that it has difficulties in recognizing multi-touch operations and accurate force intensity, and has a limitation that it is not suitable for use in a flexible wearable device.

In addition to the above-described problems, there are various technical problems that should be solved in order to develop touch and pressure recognition means suitable for wearable devices. Specifically, there are problems, for example, that waste of space occurs due to bezel areas required to arrange lines connecting multiple sensors arranged in a lattice structure, that it is difficult to achieve a high recognition rate with a touch panel having a simple structure, and that performance is deteriorated due to noises generated from a pressure recognition material.

In this regard, the inventor suggests a novel user operation recognition technique to solve the above problems.

Further, the inventor also suggests a novel audio system implemented on the basis of the user operation recognition technique.

### SUMMARY

One object of the present invention is to fully solve the aforementioned problems.

Another object of the invention is to implement a user interface means that has a simple and flexible single layer structure as compared to the prior art and can achieve a high recognition rate, by providing a user operation recognition device comprising: a substrate; at least one unit cell including a first partial electrode formed along a first pattern on the substrate and a second partial electrode formed along a second pattern on the substrate; and a pressure-responsive material formed above the at least one unit cell, wherein the material electrically connects the first partial electrode and the second partial electrode when pressure with no less than a predetermined intensity is applied to the at least one unit cell, and electric resistance of the electrically connected part is changed with the intensity of the pressure.

Yet another object of the invention is to provide an audio system implemented by the above user operation recognition device or other similar device. Here, the single layer structure inside the user operation recognition device for the audio system is not necessarily flexible.

According to one aspect of the invention to achieve the objects as described above, there is provided an audio system, comprising: a user computer to output a note; a musical instrument unit to transmit a first electrical signal to the user computer; and a user operation recognition device attached to or disposed at a specific part of the musical instrument unit to transmit a second electrical signal to the user computer, wherein the user operation recognition device is to change or adjust a note of the musical instrument unit on the basis of a touch applied to the user operation recognition device, and wherein the user operation recognition device comprises: a substrate; and at least one unit cell including a first partial electrode formed along a first pattern on the substrate and a second partial electrode formed along a second pattern on the substrate.

In addition, there are further provided other systems to implement the invention.

According to the invention, there is provided a user operation recognition device capable of achieving a high recognition rate with a simple and flexible single layer structure as compared to the prior art, so that a user interface means suitable for a wearable device can be provided.

Further, according to the invention, the intensity and direction of pressure involved in each touch operation can be accurately recognized when a multi-touch operation is inputted.

Further, according to the invention, a user can input various gesture commands only by making a minute change in force through a touching finger, or by changing a tilt of the touching finger, without having to greatly move the user's hand or finger.

Further, according to the invention, there is provided an audio system implemented by the above user operation recognition device or other similar device. Here, the single layer structure inside the user operation recognition device for the audio system is not necessarily flexible.

### BRIEF DESCRIPTION OF THE DRAWINGS

FIGS. 1A, 1B and 2 illustrate the configuration of a device for recognizing a user operation according to one embodiment of the invention.

FIG. 3 illustrates the configuration of a unit cell according to one embodiment of the invention.

FIGS. 4A and 4B illustrate the configuration of unit cells and wiring parts formed on a substrate according to one embodiment of the invention.

FIGS. 5A and 5B illustrate the configuration of unit cells asymmetrically formed on a substrate according to one embodiment of the invention.

FIG. 6 illustrates the configuration of unit cells and wiring parts both formed on one surface of a substrate according to one embodiment of the invention.

FIG. 7 illustrates a situation in which a user operation generating vertical pressure is inputted according to one embodiment of the invention.

FIGS. 8A, 8B, and 8C illustrate a situation in which a user operation generating vertical pressure is inputted according to one embodiment of the invention.

FIGS. 9A, 9B, 9C, 9D, and 9E illustrate pressure distribution produced when a user operation generating vertical pressure is inputted according to one embodiment of the invention.

FIGS. 10A, 10B, 10C, and 10D illustrate pressure distribution produced when a user operation generating vertical pressure is inputted according to one embodiment of the invention.

FIG. 11 illustrates a situation in which a user operation generating horizontal pressure is inputted according to one embodiment of the invention.

FIG. 12 illustrates a situation in which a multi-touch operation is inputted in a single touch area according to one embodiment of the invention.

FIGS. 13A and 13B illustrate pressure distribution produced when a multi-touch operation is inputted according to one embodiment of the invention.

FIG. 14 illustrates a novel audio system or music system according to one embodiment of the invention.

FIG. 15 illustrates various user operations realized on a musical instrument unit according to one embodiment of the invention.

FIGS. 16A, 16B, and 16C illustrate situations in which directional force is applied in a multi-touch manner to a user operation recognition device attached to or disposed at a keyboard or the like of a musical instrument unit according to one embodiment of the invention.

FIG. 17 illustrates an option key configured using a user operation recognition device according to one embodiment of the invention.

### DETAILED DESCRIPTION

In the following detailed description of the present invention, references are made to the accompanying drawings that show, by way of illustration, specific embodiments in which the invention can be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein can be implemented as modified from one embodiment to another without departing from the spirit and scope of the invention. Furthermore, it shall be understood that the locations or arrangements of individual elements within each of the disclosed embodiments can also be modified without departing from the spirit and scope of the invention. Therefore, the following detailed description is not to be taken in a limiting sense, and the scope of the invention, if properly described, is limited only by the appended claims together with all equivalents thereof. In the drawings, like reference numerals refer to the same or similar functions throughout the several views.

Hereinafter, preferred embodiments of the present invention will be described in detail with reference to the accompanying drawings to enable those skilled in the art to easily implement the invention.

Configuration of a User Operation Recognition Device

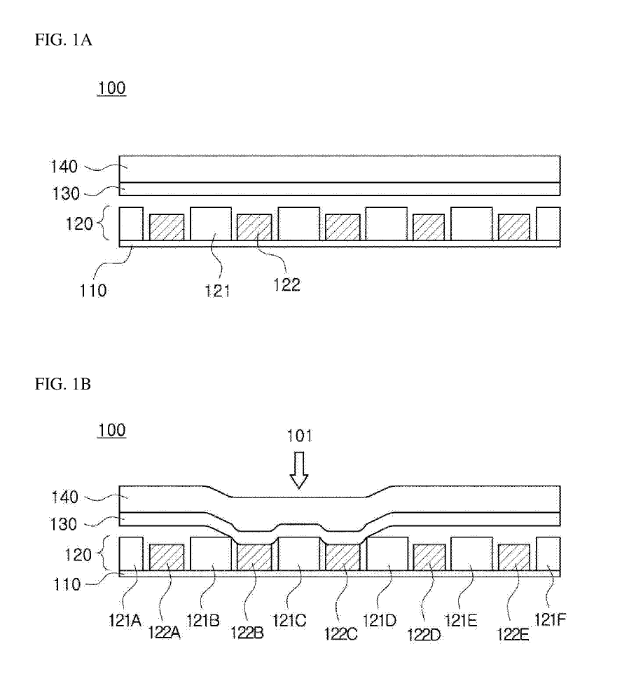

In the following, the internal configuration of a user operation recognition device 100 will be discussed in detail with reference to FIGS. 1A to 6.

FIGS. 1A, 1B and 2 illustrate the configuration of a device for recognizing a user operation according to one embodiment of the invention.

Referring to FIGS. 1A and 1B, the recognition device 100 according to one embodiment of the invention can include a substrate 110, at least one unit cell 120, and a pressure-responsive material 130. In addition, according to one embodiment of the invention, the recognition device 100 can further include a cover material 140.

First, according to one embodiment of the invention, the unit cell 120 can include a first partial electrode 121 formed along a first pattern on the substrate 110, and a second partial electrode 122 formed along a second pattern on the substrate 110.

Next, according to one embodiment of the invention, the pressure-responsive material 130 can be formed above the at least one unit cell 120.

Specifically, according to one embodiment of the invention, when pressure with no less than a predetermined intensity is downwardly applied to the at least one unit cell 120 above which the pressure-responsive material 130 is formed, the pressure-responsive material 130 can be deformed in response to the pressure to physically contact both the first partial electrode 121 and the second partial electrode 122, so that the first partial electrode 121 and the second partial electrode 122 can be electrically connected to each other. Referring to FIG. 1B, among a plurality of first partial electrodes 121A to 121F and a plurality of second partial electrodes 122A to 122E formed on the substrate 110, a part of the first partial electrodes 121B, 121C and 121D and a part of the second partial electrodes 122B and 122C, which physically contact the pressure-responsive material 130 deformed (i.e., bent) by a user operation 101 (i.e., a touch operation involving pressure), can be electrically connected to each other. As will be described below, the recognition device 100 according to the invention can recognize that a touch operation involving pressure with a predetermined intensity is inputted, by sensing an electrical connection between the first partial electrode 121 and the second partial electrode 122.

More specifically, according to one embodiment of the invention, a contact area between the pressure-responsive material 130 and the first partial electrode 121 or the second partial electrode 122 can be changed with the intensity of pressure applied to the recognition device 100, so that electric resistance of the part electrically connecting the first partial electrode 121 and the second partial electrode 122 can be changed. For example, as the contact area between the pressure-responsive material 130 and the first partial electrode 121 or the second partial electrode 122 is increased, the electric resistance of the part electrically connecting the first partial electrode 121 and the second partial electrode 122 can be reduced. As will be described below, the recognition device 100 according to the invention can recognize the intensity or direction of pressure inputted as a user operation, by sensing electric resistance of the part electrically connecting the first partial electrode 121 and the second partial electrode 122.

Next, according to one embodiment of the invention, the cover material 140 is a component for isolating and protecting the internal components of the recognition device 100 from the outside, and for enhancing sensitivity of user operation recognition, and can be made from rubber, fiber, thin metal, urethane, various films, and the like.

More specifically, referring to FIGS. 1A and 1B, the cover material can be formed to cover the top of the pressure-responsive material 130, in which case the pressure-responsive material 130 and the cover material 140 can be constructed as a single layer so that the structure of the recognition device 100 can be simplified. Further, referring to FIG. 2, it can be formed to enclose all of the substrate 110, the unit cell 120, and the pressure-responsive material 130, in which case a flexible structure can be realized and influence from external elements such as dust and water can be blocked.

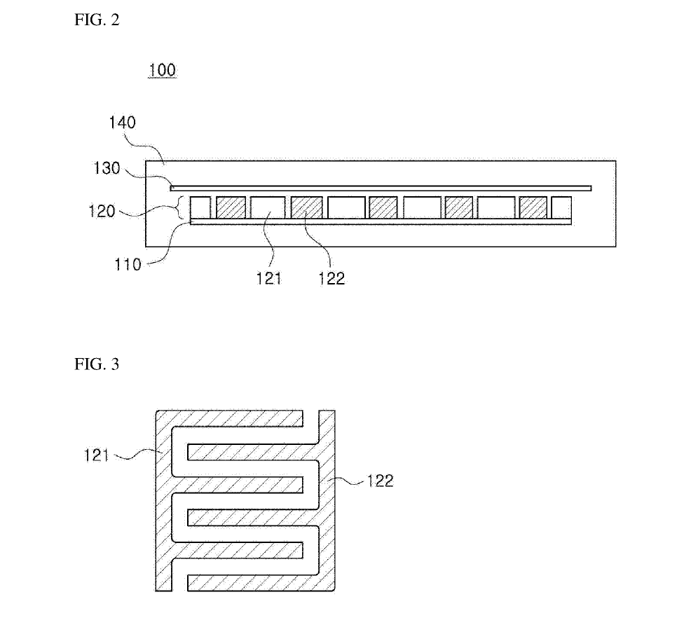

FIG. 3 illustrates the configuration of a unit cell according to one embodiment of the invention.

Referring to FIG. 3, the first pattern of the first partial electrode 121 and the second pattern of the second partial electrode 122 can be formed to have complementary shapes in order to increase sensitivity of the recognition device 100 and efficiently utilize limited space on the substrate 110.

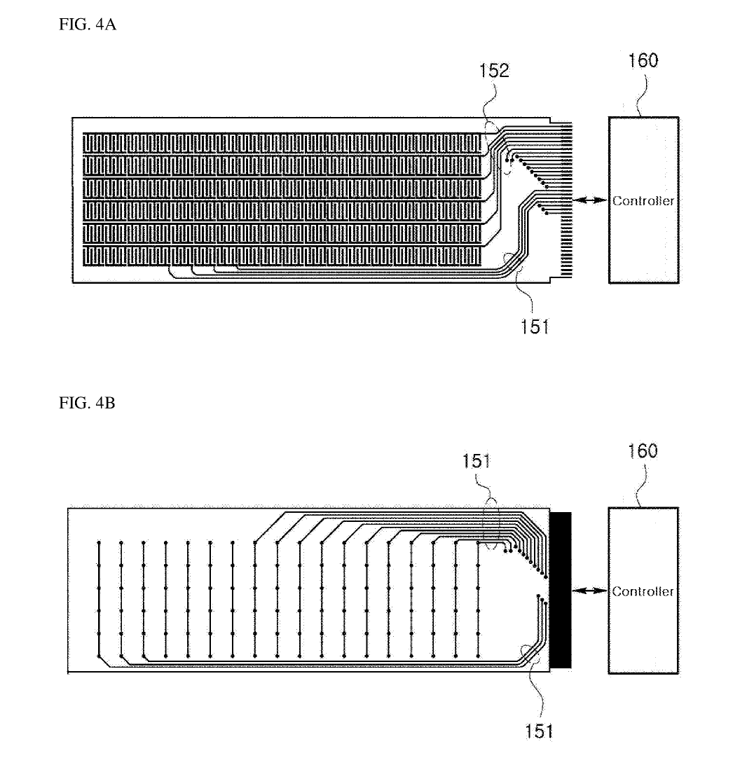

FIGS. 4A and 4B illustrate the configuration of unit cells and wiring parts formed on a substrate according to one embodiment of the invention.

According to one embodiment of the invention, as shown in FIGS. 4A and 4B, a plurality of unit cells can be arranged in a matrix structure on the substrate 110, such that first partial electrodes of the unit cells arranged in the same row can be electrically connected to each other, and second partial electrodes of the unit cells arranged in the same column can be electrically connected to each other.

Further, according to one embodiment of the invention, as shown in FIGS. 4A and 4B, the plurality of unit cells arranged in the matrix structure can be electrically connected to wiring parts 151 and 152. Specifically, the first partial electrodes of the unit cells can be electrically connected to the first wiring part 151, and the second partial electrodes can be electrically connected to the second wiring part 152.

Furthermore, according to one embodiment of the invention, at least a part of the first wiring part 151 and the second wiring part 152 can be formed on an upper surface of the substrate 110, and the remaining part thereof can be formed on a lower surface of the substrate. Thus, limited space on the substrate 110 can be efficiently utilized.

Meanwhile, according to one embodiment of the invention, as shown in FIGS. 4A and 4B, the recognition device 100 can further include a controller 160 for detecting whether an electrical connection is generated in a unit cell located at a specific row and column (e.g., the n-th column of the m-th row) through the first wiring part 151 and the second wiring part 152, and measuring electric resistance produced in the electrically connected unit cell, thereby recognizing whether a touch operation is inputted to the unit cell and recognizing the intensity and direction of pressure involved in the touch operation, with reference to the results of the above detection and measurement.

Specifically, according to one embodiment of the invention, depending on the row or column to which the first wiring part 151 or the second wiring part 152 is connected, the total length of wires constituting the corresponding wiring part can be changed, and consequentially, the electric resistance of the corresponding wiring part can be changed. Thus, it is noted that when recognizing pressure applied to a specific unit cell based on electric resistance measured in the unit cell, the controller 160 can separately consider electric resistance resulting from the length of the wiring part connected to the corresponding unit cell.

Meanwhile, according to one embodiment of the invention, the controller 160 can reside in the user operation recognition device 100 in the form of a program module. The program module can be in the form of an operating system, an application program module, or other program modules. Further, the program module can also be stored in a remote storage device that can communicate with the user operation recognition device 100. Meanwhile, such a program module can include, but not limited to, a routine, a subroutine, a program, an object, a component, a data structure and the like for performing a specific task or executing a specific abstract data type as will be described below in accordance with the invention.

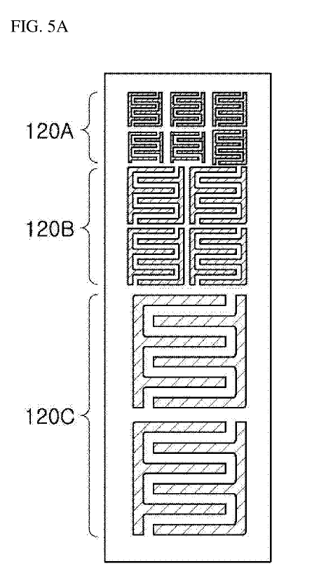

FIGS. 5A and 5B illustrate the configuration of unit cells asymmetrically formed on a substrate according to one embodiment of the invention.

According to one embodiment of the invention, at least one unit cell 120 can be uniformly arranged over all areas on the substrate 110. However, as shown in FIGS. 5A and 5B, according to a criterion such as a user operation input frequency and a required resolution, a larger number of unit cells can be arranged in certain areas on the substrate 110 than in other areas (see FIG. 5A), or smaller-sized unit cells can be arranged more closely (see FIG. 5B).

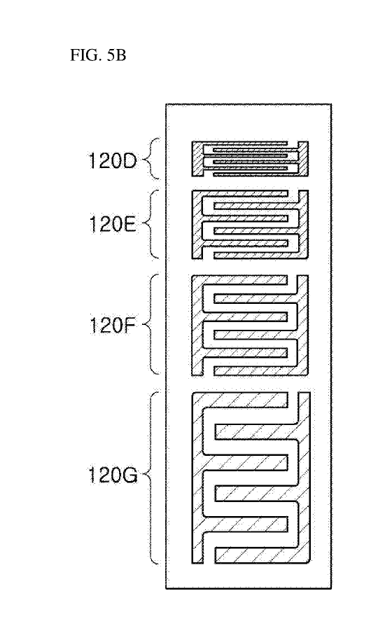

FIG. 6 illustrates the configuration of unit cells and wiring parts both formed on one surface of a substrate according to one embodiment of the invention.

Referring to FIG. 6, the first and second wiring parts 151 and 152 respectively connected to the first and second partial electrodes 121 and 122 can be both formed on one surface (i.e., upper surface) of the substrate. To this end, at least a part of the first and second wiring parts 151 and 152 can be disposed in empty areas between the unit cells. As shown in FIG. 6, since it is not necessary to separately provide bezel spaces for the wiring parts 151 and 152, space efficiency can be improved and a number of substrates can be put together to form a single large-sized touch panel.

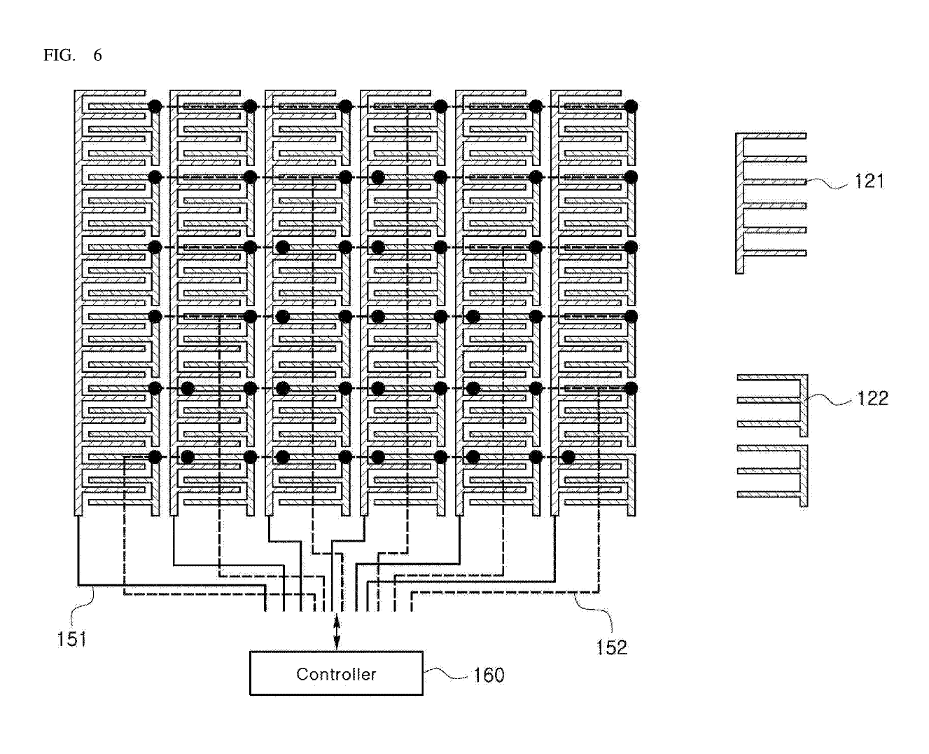

In the following, a method for recognizing a user operation will be discussed in detail with reference to FIGS. 7 to 13.

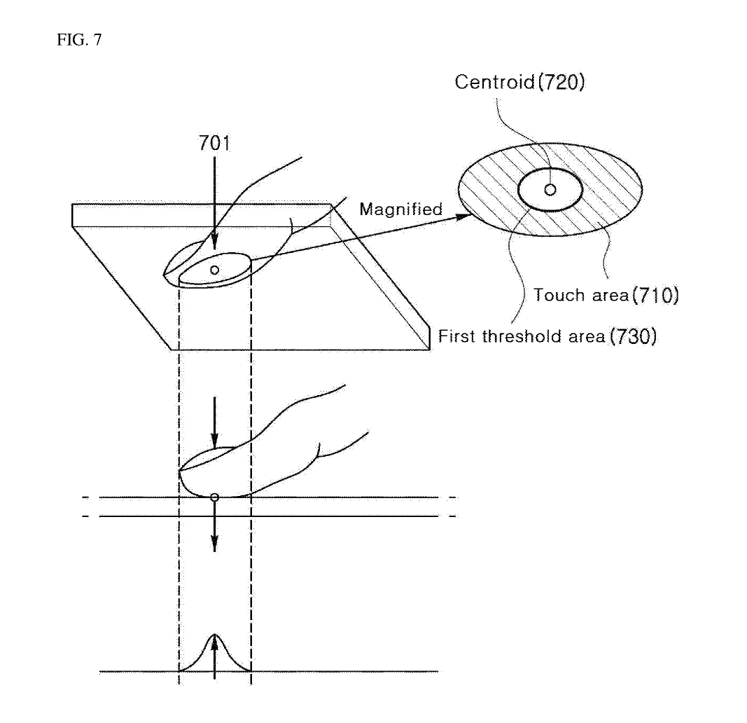

FIGS. 7 and 8A-8C illustrate a situation in which a user operation generating vertical pressure is inputted according to one embodiment of the invention.

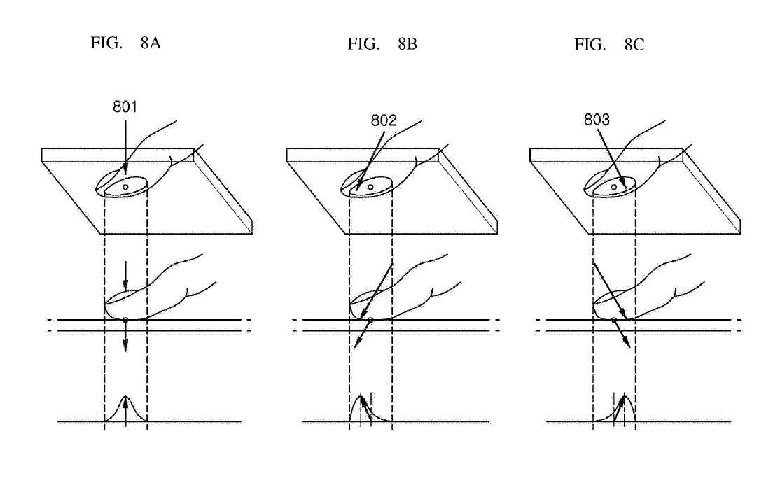

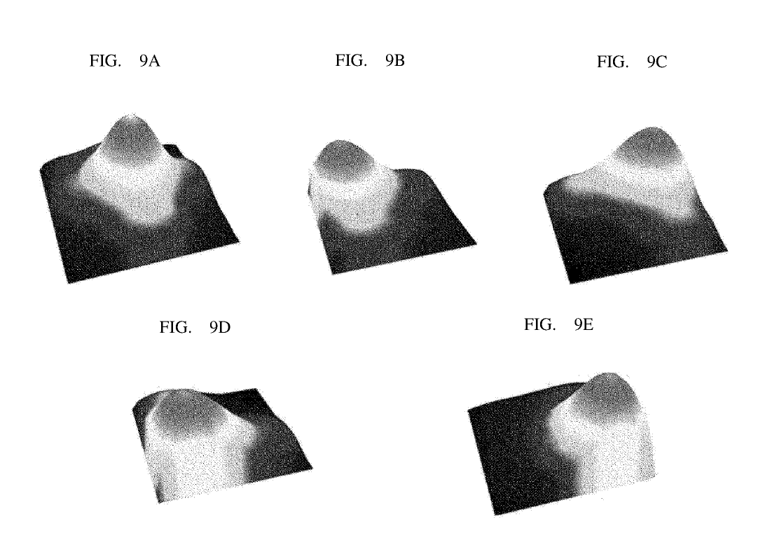

FIGS. 9A-9E and 10A-10D illustrate pressure distribution produced when a user operation generating vertical pressure is inputted according to one embodiment of the invention.

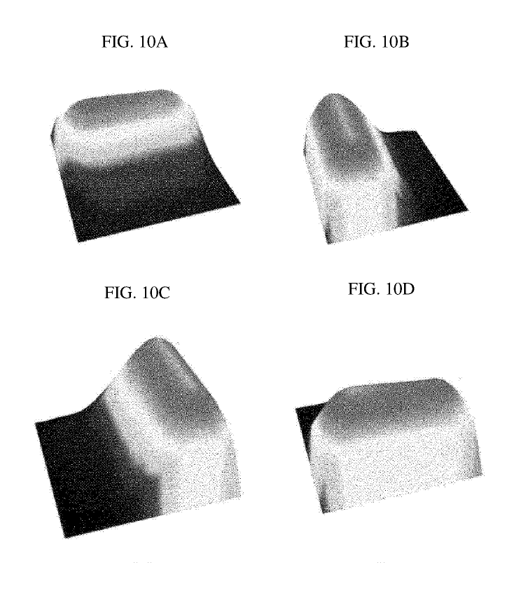

FIG. 11 illustrates a situation in which a user operation generating horizontal pressure is inputted according to one embodiment of the invention.

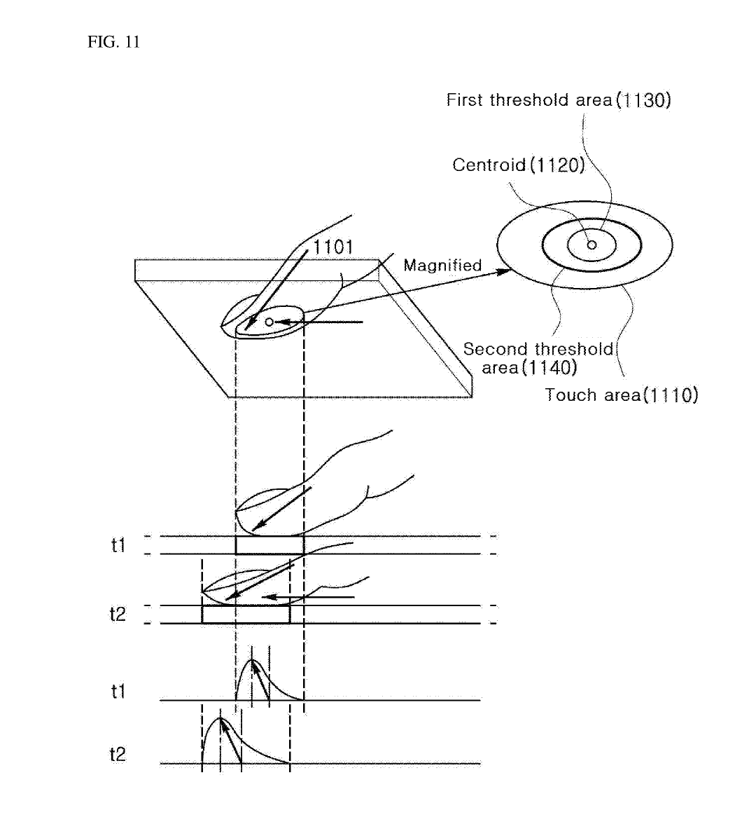

FIG. 12 illustrates a situation in which a multi-touch operation is inputted in a single touch area according to one embodiment of the invention.

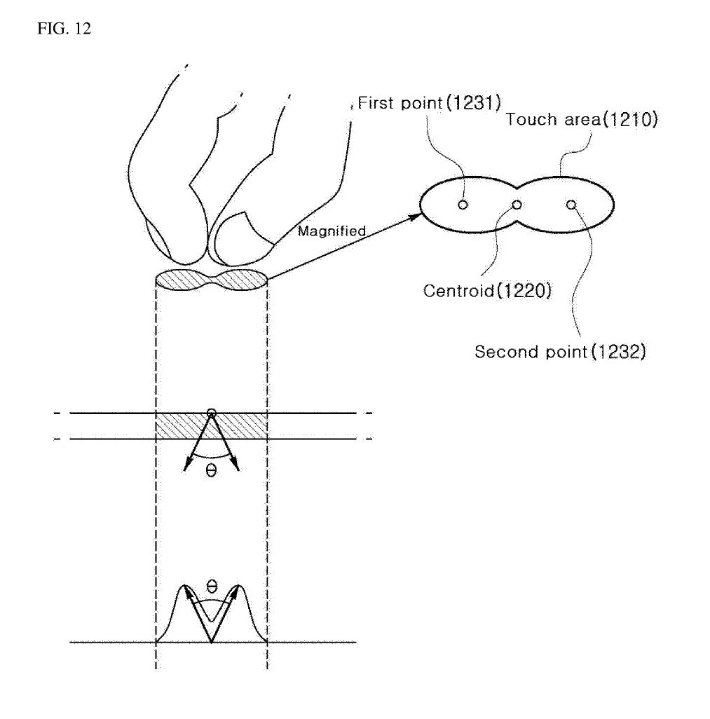

FIGS. 13A-13B illustrate pressure distribution produced when a multi-touch operation is inputted according to one embodiment of the invention.

First, referring to FIGS. 7, 8A-8C and 11, when a user operation 701, 801, 802, 803, 1101 is inputted, the recognition device 100 according to one embodiment of the invention can specify a touch area 710, 1110 with reference to information acquired from a touch recognition means, and can specify a centroid 720, 1120 corresponding to a center of pressure applied in the touch area 710, 1110 with reference to information acquired from a pressure recognition means.

Here, the position of the centroid 720, 1120 can be determined based on the intensity of the pressure, which is estimated from distribution of electric resistance measured in the touch area 710, 1110. Referring to FIGS. 9A-9E and 10A-10D, a variety of pressure distribution can be measured in the touch area so that the position of the centroid can be variously specified.

Next, referring to FIGS. 7, 8A-8C and 11, the recognition device 100 according to one embodiment of the invention can recognize intention of the user operation with reference to a relative relationship between the centroid 720, 1120 and a first threshold area 730, 1130 or a second threshold area 1140 predetermined in the touch area 710, 1110. Here, the first threshold area 730, 1130 and the second threshold area 1140 can be determined in the touch area 710, 1110, and the second threshold area 1140 can be determined to be larger than the first threshold area 730, 1130.

Specifically, when the centroid 720 is detected to be included in the first threshold area 730, 1130, the recognition device 100 according to one embodiment of the invention can determine that the pressure is concentrated on the center of the touch area 710, 1110, and recognize that the inputted user operation is intended for vertical pressure. Further, when the centroid 720, 1120 is out of the first threshold area 730, 1130 but included in the second threshold area 1140, the recognition device 100 according to one embodiment of the invention can determine that the pressure is concentrated somewhat away from the center of the touch area 710, 1110, and recognize that the inputted user operation is intended for horizontal pressure. Furthermore, when the centroid 720, 1120 is out of the second threshold area 1140, the recognition device 100 according to one embodiment of the invention can determine that the pressure is concentrated on the periphery far away from the center of the touch area 710, 1110, and recognize that the inputted user operation is intended to move the touch area 710, 1110 itself.

Meanwhile, according to one embodiment of the invention, when a multi-touch operation involving pressure is inputted, the recognition device 100 can perform the above-described recognition process for each of multiple touch areas specified by the multi-touch operation.

Further, referring to FIG. 12, when a multi-touch operation is input in one touch area (i.e., when the one touch area 1210 includes two or more points 1231, 1232 at which pressure with an intensity greater than that of the pressure measured at the centroid 1220 (which is the center of the pressure distribution) is measured, and the two or more points 1231, 1232 are spaced apart by no less than a predetermined interval), the recognition device 100 according to one embodiment of the invention can recognize that a touch operation involving pressure is inputted at each of the two or more points 1231, 1232. Here, whether or not the two or more points 1231, 1232 are spaced apart by no less than a predetermined interval can be determined based on, for example, whether the angle between the lines of action (i.e., vectors) of the force produced at each of the two or more points 1231, 1232 is not less than a predetermined angle, or whether the interval between the two or more points 1231, 1232 is greater than a predetermined threshold value.

Referring to FIGS. 13A-13B, it can be seen that a variety of pressure distribution can be produced when one touch area includes two or more points at which pressure with an intensity greater than that of the pressure measured at the centroid is measured. However, the configuration for recognizing the intention of the user operation based on the signal detected by the recognition device 100 is not necessarily limited to the above-described embodiments, but can be modified without limitation as long as the objects of the invention can be achieved.

Applications of the Invention

A novel audio system can be provided using a user operation recognition device according to the invention or other similar device. It will be discussed below with reference to the drawings.

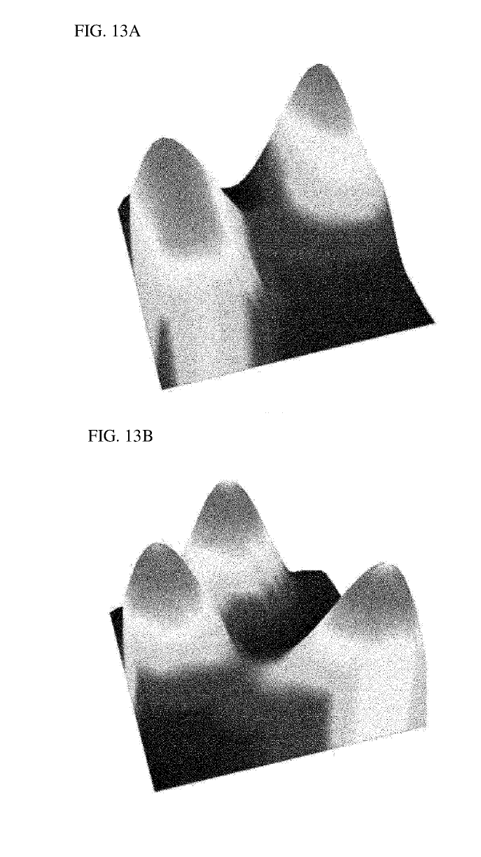

FIG. 14 illustrates a novel audio system or music system according to one embodiment of the invention.

(For convenience, the description will be focused on a music system that can allow a user to play music, though the present invention can be employed for all types of audio systems.) The music system can include a user computer 100A, a musical instrument unit 200A, and a MIDI shield and controller 300A.

As shown, the user computer 100A is a computer including an audio interface for input and output of musical information, and any type of digital equipment having a memory means and a microprocessor for computing capabilities, such as a desktop computer, a notebook computer, a workstation, a personal digital assistant (PDA), a web pad, a mobile phone, and a smart device (e.g., a smart phone, a smart pad, a smart watch, etc.) can be adopted as the user computer 100A according to the invention.

The user computer 100A can receive an electrical signal or other data from a user operation recognition device (not shown), which can be attached to or disposed at the musical instrument unit 200A or the MIDI shield and controller 300A, or a part (e.g., a keyboard) of the musical instrument unit 200A, as necessary. The electrical signal or data can be processed by the audio interface and outputted as music that can be heard by a person. To this end, the audio interface can be configured to include a program for playback of known MIDI sources.

Meanwhile, in some cases, the known MIDI shield and controller 300A can be further employed as shown to interpret the electrical signal or data transmitted by the musical instrument unit 200A or the user operation recognition device to the user computer 100A, according to MIDI standards. (Here, the electrical signals transmitted by the musical instrument unit 200A and the user operation recognition device can be referred as a first electrical signal and a second electrical signal, respectively, for convenience.) The MIDI shield and controller 300A can take charge of communication from the user computer 100A to the musical instrument unit 200A between the user computer 100A and the musical instrument unit 200A. However, the functions of the MIDI shield and controller 300A can also be performed by the audio interface.

Meanwhile, the user computer 100A can further include an output device (not shown) for outputting music. The output device can be, for example, a device for converting an electrical signal generated by the audio interface into a note using a magnet or the like. The output device can include known mountable speakers, multi-channel speakers, tactile output speakers, headphones, and the like.

The musical instrument unit 200A can be composed of a musical instrument such as a synthesizer or an electric piano, which a user can naturally touch and operate. The musical instrument unit 200A can be composed of any known electric/non-electric musical instrument. For example, the musical instrument can be a wind instrument, a string instrument, a percussion instrument, or the like. The user operation recognition device can be attached to or disposed at a keyboard or the like of the musical instrument unit 200A. Alternatively, the user operation recognition device can be originally included in the musical instrument unit 200A, rather than be attached to or disposed at the musical instrument unit 200A, to recognize a touch operation of the user thereon. The touch operation can be classified and analyzed as various touch operations to be described later. For example, it can be classified and analyzed according to the pressure of the touch operation, the direction of movement, and the like. Such classification and analysis can be realized by the above-described user operation recognition unique to the invention, but can also be realized by other known techniques, such as a technique using a pressure sensor or a piezoelectric sensor.

Therefore, when the above-described musical instrument unit 200A is employed, user inputs can be diversified because the user can not only depress keys but also perform various operations consciously or unconsciously, as the user plays music by touching a keyboard or the like of the musical instrument unit 200A.

The musical instrument unit 200A can perform communication with the user computer 100A by means of known wired/wireless communication. For example, in performing the communication, well-known technologies (such as wired communication, wireless data communication, wireless Internet communication, Wi-Fi communication, LTE standard communication, Bluetooth communication, and infrared communication) can be applied without limitation.

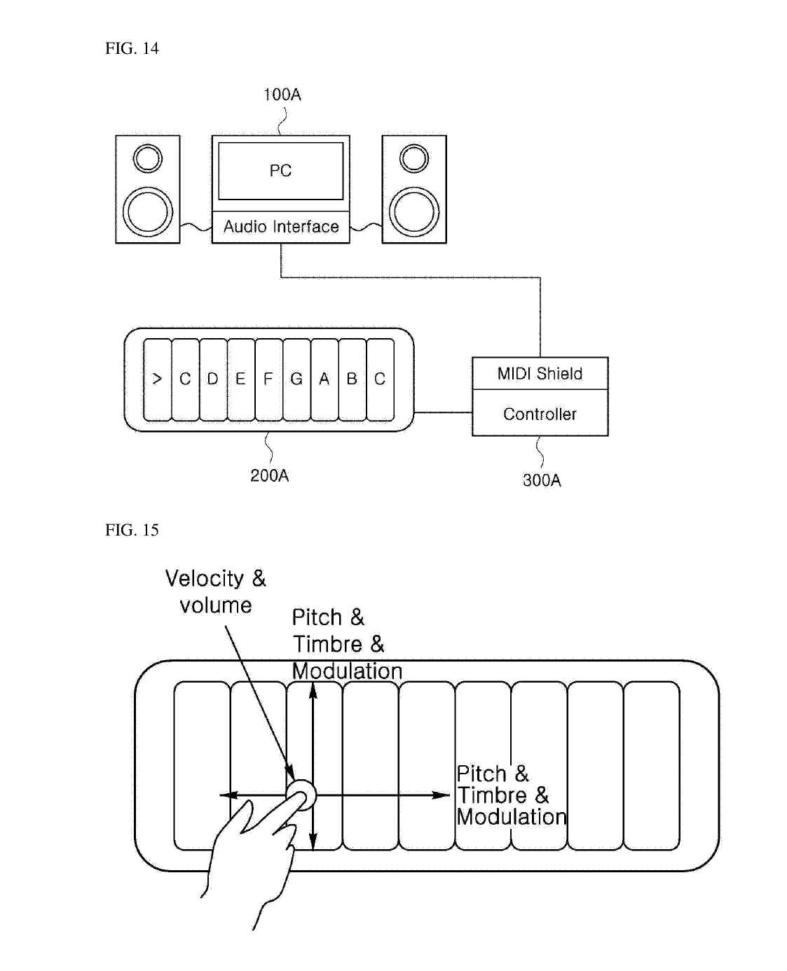

FIG. 15 illustrates various user operations realized on a musical instrument unit according to one embodiment of the invention. As shown, according to the invention, operations on the musical instrument unit 200A can be dramatically diversified. For example, according to the pressure applied when a user presses a specific part such as a keyboard on the musical instrument unit 200A, or the velocity at which the user moves his/her finger for the touch, the volume of a note generated in response to the depression of the corresponding key can be adjusted. Meanwhile, according to an operation that the user can perform in the process of depressing the key or the like, e.g., an operation of sweeping up or down the finger in a longitudinal direction of the key, the pitch or timbre of the note can be adjusted, and a modulation or a vibrato effect can also be realized. Of course, such an operation can also be performed in a direction across multiple keys, rather than in a longitudinal direction of one key.

Meanwhile, although the case where the input to the keyboard instrument varies in accordance with the user operation has been illustrated above, the present invention is not necessarily limited thereto. For example, when the musical instrument unit 200A is not composed of a keyboard instrument, various user operations can also be realized with respect to other parts constituting the musical instrument unit 200A, such as a pipe of a wind instrument, a string of a string instrument, and a percussion surface or a stick of a percussion instrument.

Among the user operations as described above, those particularly illustrative are summarized below.

NoteOn operation: When a keyboard or the like is touched, a note assigned to the corresponding position is played back. The value of the key depression velocity can be determined according to the value of the pressure detected by the user operation recognition device at the moment of the touch.

Volume adjustment operation: The volume can be adjusted according to the value of the pressure applied to one key and detected by the user operation recognition device.

Pitch band operation: As the touch position on a key is moved upward/downward/leftward/rightward, the pitch of the corresponding note can be continuously adjusted.

Modulation operation: When a user tilts a finger upward/downward/leftward/rightward while holding a touch on the keyboard, the user can adjust the volume or pitch of the note of the corresponding position while simultaneously giving vibrato or other special effects.

NoteOff operation: When a touch on the keyboard is released, the corresponding note can be faded slowly or quickly. The velocity at which the note is faded can be adjusted according to the velocity at which the pressure caused by the touch is released. Depending on the velocity, an effect such as a fade-out can be implemented.

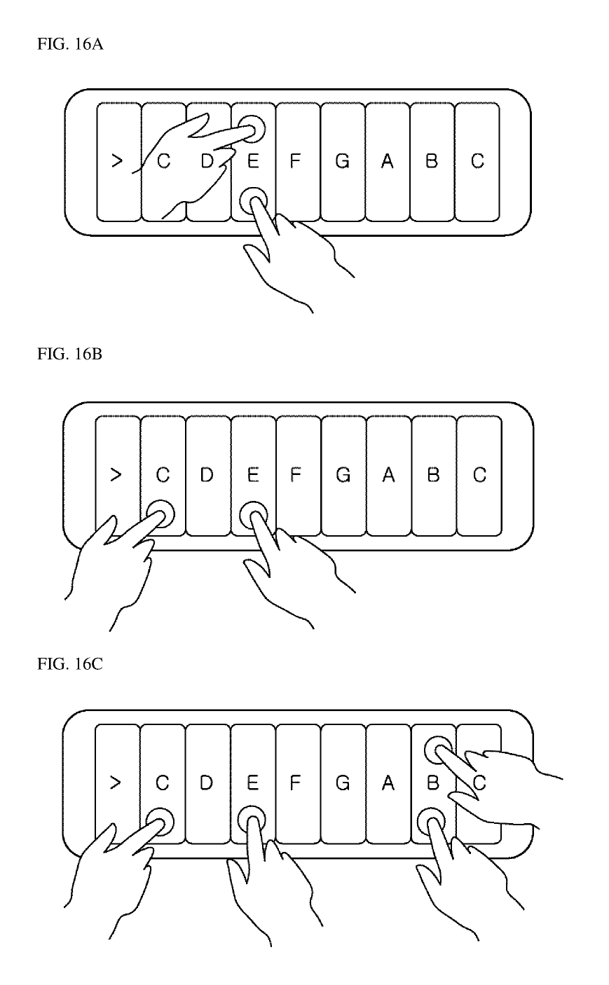

FIGS. 16A, 16B, and 16C illustrate situations in which directional force is applied in a multi-touch manner to a user operation recognition device attached to or disposed at a keyboard or the like of a musical instrument unit according to one embodiment of the invention.

FIG. 16A illustrates a situation in which multiple touch operations are performed in one key. Such a multi-touch can be easily detected by the user operation recognition device. Accordingly, the note related to the corresponding position can be outputted in various ways according to the combination of the directions, pressures, and the like of the multi-touch. For example, when the multi-touch is performed in directions approaching or departing from each other, the pitch or timbre can be changed according to the multi-touch.

FIG. 16B illustrates a situation in which a touch operation is performed on each of two or more keys. In this situation, the respective notes can also be outputted in various ways according to the direction, pressure, and the like of each touch operation. In this case, it is very easy for one user to give various effects to each chord.

FIG. 16C illustrates a situation encompassing the above two situations. In the illustrated situation, three notes can be outputted while various effects on each note can be generated at the same time.

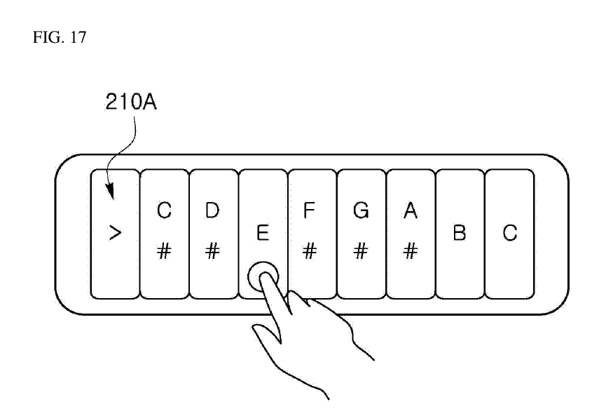

FIG. 17 illustrates an option key configured using a user operation recognition device according to one embodiment of the invention.

As shown, an option key 210A configured by the user operation recognition device can be disposed on the left edge of the musical instrument unit 200A. When a user touches the option key implemented by the attached or disposed user operation recognition device, an option can be applied to a note outputted by a keyboard or the like being used together, according to a predetermined preference for the user operation recognition device. For example, the option can be a semitone up, a semitone down, an octave change, or the like. To this end, the user operation recognition device can generate and transmit a predetermined electrical signal. As described above, the generated electrical signal can be delivered to the user computer 100A via the MIDI shield and controller 300A, as necessary. In this process, the user computer 100A or the MIDI shield and controller 300A can perform a semitone up, a semitone down, an octave change, or the like of the outputted note.

The embodiments according to the invention as described above can be implemented in the form of program instructions that can be executed by various computer components, and can be stored on a non-temporary computer-readable recording medium. The non-temporary computer-readable recording medium can include program instructions, data files, data structures and the like, separately or in combination. The program instructions stored on the non-temporary computer-readable recording medium can be specially designed and configured for the present invention, or can also be known and available to those skilled in the computer software field. Examples of the non-temporary computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like. The above hardware devices can be configured to operate as one or more software modules to perform the processes of the present invention, and vice versa.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes can be made from the above description.

Therefore, the spirit of the present invention shall not be limited to the above-described embodiments, and the entire scope of the appended claims and their equivalents will fall within the scope and spirit of the invention.

What is claimed is:

1. An audio system, comprising:
a user computer to output a note;
a musical instrument unit to transmit a first electrical signal to the user computer; and
a user operation recognition device attached to or disposed at a specific part of the musical instrument unit to transmit a second electrical signal to the user computer,
wherein the user operation recognition device is to change or adjust a note of the musical instrument unit on the basis of a touch applied to the user operation recognition device, and
wherein the user operation recognition device comprises:
a substrate; and
at least one unit cell including a first partial electrode formed along a first pattern on the substrate and a second partial electrode formed along a second pattern on the substrate.

2. The audio system of claim 1, wherein the musical instrument unit is composed of a keyboard instrument, and the specific part is a keyboard.

3. The audio system of claim 2, wherein the touch is made in a longitudinal direction with respect to the specific part.

4. The audio system of claim 1, wherein the specific part consists of a single part, and the touch is a multi-touch made to the specific part.

5. The audio system of claim 1, wherein the specific part consists of multiple parts, and the touch is a multi-touch made to each of the parts.

6. The audio system of claim 1, wherein the changing of the note is at least one of a pitch change, a timbre change, and a modulation.

7. The audio system of claim 1, wherein the changing of the note is addition of a special effect.

8. The audio system of claim 1, wherein the adjusting of the note is volume adjustment.
